(19) United States
(12) Patent Application Publication
(10) Pub. No.: US 2024/0280094 A1
(43) Pub. Date: Aug. 22, 2024

(54) INSTALLATION FOR PUMPING CRYOGENIC FLUID AND FILLING STATION COMPRISING SUCH AN INSTALLATION

(71) Applicant: L'Air Liquide, Société Anonyme pour I'Exploitation des Procédés Georges Claude, Paris (FR)

(72) Inventors: Cyril BENISTAND-HECTOR, Sassenage (FR); Martin GRASER, Metzingen (DE)

(21) Appl. No.: 18/569,900

(22) PCT Filed: May 18, 2022
(86) PCT No.: PCT/EP2022/063378

§ 371 Date: Dec. 13, 2023

(30) Foreign Application Priority Data
Jun. 14, 2021 (FR) FR2106232

(51) Int. Cl. F04B 37/08; F04B 39/00; F17C 5/02

(52) U.S. Cl. CPC F04B 37/08; F04B 39/0022; F17C 5/02; F17C 2205/0352; F17C 2221/012; F17C 2223/0161; F17C 2227/0135

(57) ABSTRACT

An installation for pumping cryogenic fluid including a fluidtight enclosure to contain a bath of cryogenic fluid, the enclosure housing a compression chamber communicating with the bath and a movable piston to compress the fluid in the compression chamber, the piston being mounted at a first end of a rod, the apparatus including a drive mechanism driving a second end of the rod in a back and forth movement in a longitudinal direction, the drive mechanism including a motor equipped with a rotary shaft and a mechanical conversion system converting the rotational movement of the rotary shaft into a translational movement, in the configuration of operation of the installation, the longitudinal direction of travel of the piston rod being vertical, the motor being fixed rigidly to an upper mounting structure.

### CROSS REFERENCE TO RELATED APPLICATIONS

This application is a 371 of International Application No. PCT/EP2022/063378, filed May 18, 2022, which claims priority to French Patent Application No. 2106232, filed Jun. 14, 2021, the entire contents of which are incorporated herein by reference.

### BACKGROUND

The invention relates to an installation for pumping cryogenic fluid, and to a filling station comprising such an installation.

The invention relates more particularly to an installation for pumping cryogenic fluid comprising a fluidtight enclosure intended to contain a bath of cryogenic fluid, the enclosure housing a compression chamber communicating with the bath and a piston that is able to move in order to compress the fluid in the compression chamber, the piston being mounted at a first end of a rod, the apparatus comprising a drive mechanism driving a second end of the rod in a back and forth movement in a longitudinal direction, the drive mechanism comprising a motor equipped with a rotary shaft and a mechanical conversion system converting the rotational movement of the rotary shaft into a translational movement, in the configuration of operation of the installation, the longitudinal direction of travel of the piston rod being vertical, the motor being fixed rigidly to an upper mounting structure.

A conventional solution for actuating a reciprocating piston pump uses a motor and a mechanical conversion system (connecting rod/crank and/or reduction gear and/or gearbox system) to convert the movement of the rotary shaft of the motor into a translational movement.

The majority of known cryogenic pumps operate with the piston axis horizontal. This can be done with a vacuum insulated cold end.

In hydrogen refuelling stations, the pump needs to be available for pumping 24-hours a day. It is therefore preferable for the cold end to be placed in a vacuum insulated bath (Dewar vessel) of cryogenic liquid (sump), to ensure that it remains cold. In such instances, it is more appropriate for the piston to be oriented vertically.

In such a case, certain adaptations are needed in order to optimally support the pump and the drive actuator (motor and associated mechanism). A Cardan system may be employed to transmit the torque from the rotation output of the gearbox of the motor to the crank of the mechanical unit that converts the rotational movement supplied by the motor into a reciprocating translational movement of the piston rod. This allows for optimal mounting without demanding overly close tolerances.

However, in this configuration, a torque is transferred through the axle of the Cardan to the mechanism that converts the rotational movement into a translational one. There is effectively no satisfactory counter-torque system. The casing of the mechanism needs to withstand this torque. The torque will thus be transferred through the entire pumping structure. This is unacceptable particularly as regards the mechanical strength of the tank containing the bath and the overall strength of the structure.

Even if these elements were dimensioned accordingly, there would still be risks with regard to the potential problems of vibration and fatigue.

With a hydraulic solution, it is relatively easy to position the pump vertically because the hydraulic ram is relatively small. The enormous supply unit may itself be relocated several meters away. However, the overall layout and effectiveness are not well suited to the application.

A solution involving a linear actuator with a roller screw is also easy to implement on account of its compactness. However, this solution is not well suited to high-pressure cryogenic applications because of its poor efficiency and reliability.

### SUMMARY

An aim of the present invention is to overcome all or some of the prior-art drawbacks outlined above.

To this end, the installation according to the invention, in other respects in accordance with the generic definition thereof given in the above preamble, is essentially characterized in that the mechanical conversion system is rigidly connected to a motor via a tubular structure positioned around the rotary shaft, the tubular structure comprising a first end rigidly connected to the motor and/or to a casing surrounding same and a second end rigidly connected to the mechanical conversion system and/or to a casing surrounding same, said tubular structure being able and configured to absorb at least some of the torque and/or the forces generated in the transmission of movement between the motor and the enclosure.

Furthermore, embodiments of the invention may comprise one or more of the following features:
the tubular structure comprises an opening for access to the rotary shaft,
the tubular structure is made up of several assembled parts, for example two assembled half-shells,
the rotary shaft is coupled to the mechanical conversion system via an axle comprising a connecting system such as a rigid connection or a Cardan joint,
the motor is suspended from its upper mounting structure,
the mechanical conversion system is suspended from the motor via the tubular structure,
the fluidtight enclosure is suspended from the mechanical conversion system,
the installation comprises a tank of liquefied gas, notably of hydrogen, said tank being fluidically connected by a set of pipes to the enclosure, these pipes being configured to supply the compression chamber with fluid that is to be compressed and to recover the fluid that has vaporized in the enclosure,
the mechanical conversion system to convert the rotational movement of the rotary shaft into a translational movement of the piston rod is of the connecting rod/crank type,
the motor is housed in a casing fixed to the upper mounting structure,
the installation it is of the type having one compression stage, which is to say that the fluid is compressed just once, between an inlet system and a discharge system in the compression chamber,
the installation is of the type having two compression stages, which is to say that the fluid is compressed twice, between an inlet system and a discharge system, the installation comprising two compression chambers, an inlet system communicating with a first compression chamber, a transfer system for communicating with the first and second compression chamber and configured to allow fluid compressed in the first compression chamber to be transferred to the second compression chamber, the mobile piston alternately compressing the fluid in the first and second compression chambers depending on the direction in which it is travelling, and a discharge system communicating with the second compression chamber,
the compression of the fluid in the compression chamber is brought about by a pulling or a compressing of the rod.

The invention also relates to a station for filling tanks or pipes with pressurized gas and comprising a source of liquefied gas, notably a tank of liquefied hydrogen, a withdrawal circuit having a first end connected to the source and at least one second end intended to be connected to a tank to be filled, the withdrawal circuit comprising a pumping installation according to any one of the features above or below.

The invention may also relate to any alternative device or method comprising any combination of the features above or below within the scope of the claims.

### BRIEF DESCRIPTION OF THE DRAWINGS

Further particular features and advantages will become apparent from reading the following description, which is given with reference to the figures, in which:

FIG. 1 shows a schematic and partial perspective view illustrating a first possible embodiment of a pumping installation according to the invention,

FIG. 2 shows a partial and schematic perspective view illustrating a detail of the support structure for the pumping installation according to the invention,

FIG. 3 shows a schematic and partial view in cross section illustrating a detail of the installation and in particular an example of the structure of a compression chamber,

FIG. 4 shows a schematic and partial view illustrating an example of a filling station using such a compression apparatus.

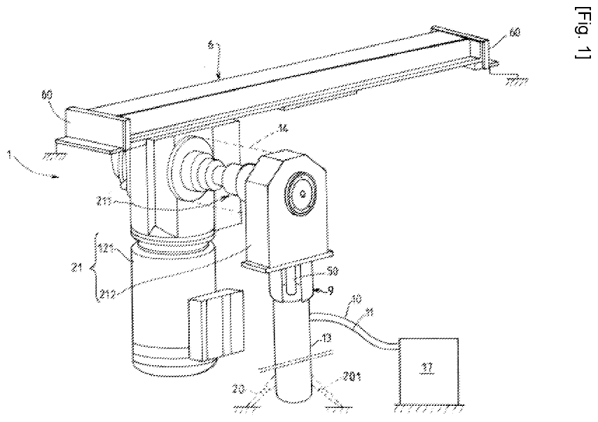

### DETAILED DESCRIPTION OF PREFERRED EMBODIMENTS

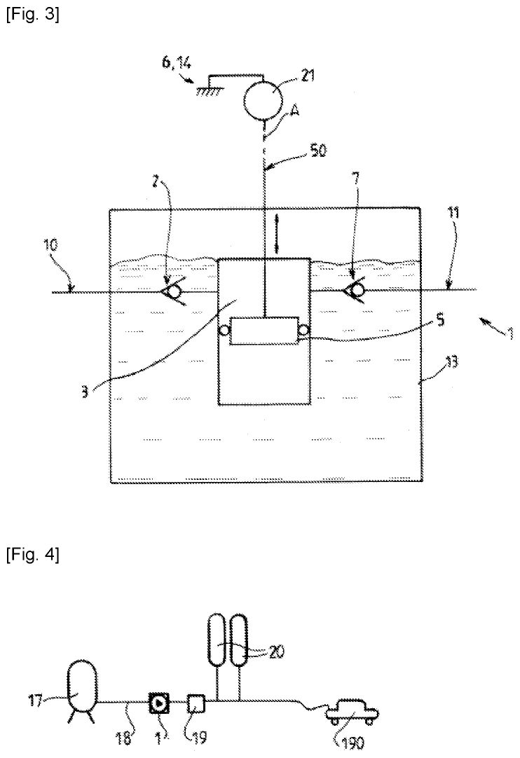

The installation 1 depicted for pumping cryogenic fluid comprises a fluidtight enclosure 13 intended to contain a bath of cryogenic fluid. The enclosure 13 may be vacuum thermally insulated and houses a compression chamber 3 that communicates with the bath and a mobile piston 5 able to move in order to compress the fluid in the compression chamber 3, see FIG. 3.

The piston 5 is mounted at a first end of a piston rod 50. The apparatus 1 comprises a drive mechanism 21 for driving a second end of the rod 50 in a back and forth motion in a longitudinal direction A of travel.

The drive mechanism 21 comprises a motor 121 (with a gearbox or the like where appropriate) equipped with a rotary shaft 211 and a mechanical conversion system 212 that converts the rotational movement of the rotary shaft 211 into a translational movement of the rod 50. The mechanical conversion system 212 to convert the rotational movement of the rotary shaft 211 into a translational movement of the piston rod 50 may be of the connecting rod/crank type, and is housed inside a casing.

As illustrated, the drive mechanism (motor 121 and conversion system 212) is positioned above the enclosure 13.

This arrangement makes it possible to limit thermal losses (because the hot parts are above the cold parts).

The rotary shaft 211 of the motor 121 is coupled to the mechanical conversion system 212 via an axle comprising a connecting system such as a rigid connection or a Cardan joint, for example.

A coupling involving a Cardan joint may allow greater tolerances on assembly.

The Cardan-joint coupling between the two entities also makes it possible for the “useful” torque to be transferred optimally with relative ease of maintenance.

These elements (motor 121 and mechanical conversion system 212) may be housed in respective casings.

The movement conversion system 212 (and its casing) may easily be removed in order to access the cold end positioned vertically beneath the mechanism (below a crankshaft notably in the case of a connecting-rod/crank mechanism).

As illustrated, when the installation 1 is in an operating configuration, the longitudinal direction A of travel of the piston rod 50 is vertical. The motor 121 is fixed rigidly to an upper mounting structure 6 comprising, for example, a horizontal beam.

The motor 121 may notably be suspended from its upper mounting structure 6.

The upper mounting structure for the motor 121 may comprise a first horizontal support beam(s) assembly 6, these beams being connected to a load-bearing structure 60 comprising vertical legs resting on the ground.

The mechanical conversion system 212 is rigidly connected to a motor 121 via a tubular structure 14 positioned around the rotary shaft 211. This tubular structure 14 comprises a first end rigidly connected to the motor 121 and/or to a casing surrounding same and a second end rigidly connected to the mechanical conversion system 212 and/or to a casing surrounding same. This tubular structure 14, which for example is cylindrical, is rigid and is able and configured to absorb at least some of the torque and/or the forces generated in the transmission of movement between the motor 121 and the enclosure 13. The cross section of the tubular structure 14 may have shapes other than circular, for example square, rectangular or some other shape.

The mechanical conversion system 212 may thus be suspended from the motor 121 via the tubular structure 14. The fluidtight enclosure 13 may itself be suspended from the mechanical conversion system 212.

What this means to say is that an upper end of the vessel 13 may be suspended from and/or connected to a lower end of the mechanical conversion system 212 (notably the casing thereof) by a connecting member 9 such as one or more axles and/or a muff-coupling sleeve. The lower end of the vessel 13 may thus be situated above ground level without resting on a lower support.

This tubular structure 14 effectively has good torsional strength so that it can absorb the torque and/or the forces transmitted by the motor on each end of the axle 211.

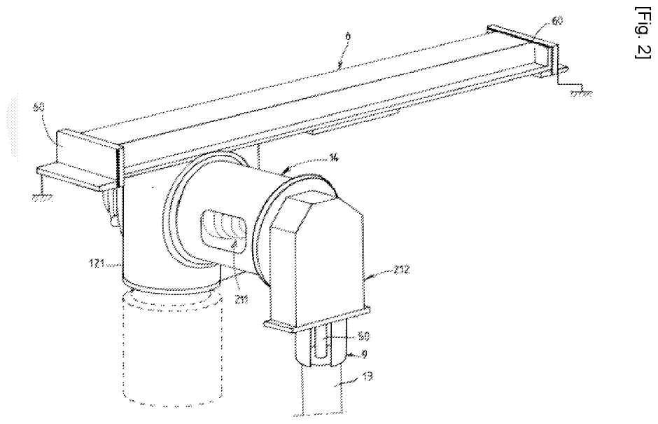

As illustrated in FIG. 2, the tubular structure 14 may comprise an opening 15 for access to the rotary shaft 211, notably to a Cardan joint in instances in which the shaft 211 possesses a Cardan joint. Specifically, the rotary shaft 211 may be coupled to the mechanical conversion system 212 via an axle comprising a connecting system such as a rigid connection or a Cardan joint. This allows interventions without the need for full disassembly. This opening 15 may where applicable be able to be closed by a removable cover.

The tubular structure 14 may be made up of several assembled parts, for example two half-shells assembled around the shaft 211 along longitudinal joins.

In the example illustrated, the installation 1 comprises a tank 17 of liquefied gas, notably of hydrogen. The tank 17 is fluidically connected to the enclosure 13 by a set of pipes 10, 11 which pipes are configured to supply the compression chamber 3 with fluid that is to be compressed and to recover any boil-off gas generated in particular from fluid that may have vaporized in the enclosure 13.

This tank 17 may rest on the ground. As mentioned previously, the pipes 10, 11 may comprise flexible portions.

Specifically, as described in greater detail hereinafter, the cryogenic pipes connecting this vessel 13 and a tank 17 of cryogenic liquid may be flexible pipes so as to absorb thermal contractions and tolerate minor misalignments.

The structure of the installation offers a number of advantages.

Aside from transmitting motion between the motor 121 and the axle 50 without unwanted torque, the structure is particularly well suited to ease of maintenance (for example by the removal of a suspended element, notably a casing, in order to access the mechanism(s)).

The drive mechanism (motor+possibly reduction gear or gearbox) does not need to be removed during maintenance of the cold side of the cryogenic pumping part. The frequency of maintenance of the motor part 121 is actually generally lower than for the cold drive part. The proposed structure allows the cold part 212 to be accessed without removing the motor part 121 (visual inspection, cleaning, replacement of seals, lubrication, etc.).

The installation 1 is compact and positioned low to the ground. This is well suited to its integration into a filling station.

The motor 121 and the associated reduction gear may be standard elements, notably with an explosion-proof structure or enhanced safety.

The motor 121 and the conversion system 212 may be positioned in various relative configurations, notably horizontally, vertically, with the shaft 211 rotating in or perpendicular to this axis depending on the model of reduction-gear system 212 used (helical gear, helical bevel gear, worm gear, helical parallel shaft, right-angle reducer).

The assembly comprising the motor 121 and its reducer, if any, illustrated and from which the rotary axle 211 projects may, where applicable, advantageously be replaced by a torque motor (which therefore has no reduction gearbox or gearbox). In such an instance, there is no problem with oil due to lubrication. In addition, in such an instance, the assembly is more compact and lighter in weight. In addition, such a motor assembly offers greater flexibility in the setting of the speed (speed, and notably rotational-speed, profile).

FIG. 3 schematically illustrates an example of a compression chamber (single compression stage) with an intake system 2 communicating with the compression chamber 3 and configured to allow fluid that is to be compressed to enter the compression chamber 3, a piston 5 able to move in order to compress the fluid in the compression chamber 3, and a discharge system 7 communicating with the compression chamber 3 and configured to allow the compressed fluid to exit. The compression of the fluid in the compression chamber may be brought about by a pulling or a compressing of the rod 50.

Of course, the invention also applies to pumps having two compression stages (for example, two compression chambers and two compression stages each for a respective one of the two directions of translational movement of the piston).

FIG. 4 depicts an example of a station for filling tanks or pipes with pressurized gas and comprising a source 17 of liquefied gas, notably liquefied hydrogen, a withdrawal circuit 18 having a first end connected to the source and at least one second end intended to be connected to a tank 190 to be filled. The withdrawal circuit 18 comprising a compression apparatus 1 conforms to the installation in accordance with any one of the above features.

Although the enclosure 13 is suspended from the mechanical conversion system 212, it is possible to envision providing one or more legs connecting the enclosure to the ground, where applicable via a flexible and/or adjustable connection. This may be during the maintenance operation and/or in a situation of normal operation in order, for example, to support the enclosure 13 better and for example absorb any vibrations there might be. Likewise, the lower end of the enclosure could rest on a support, for example in a housing which holds it laterally.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-10. (canceled)

11. An installation for pumping cryogenic fluid comprising a fluidtight enclosure configured to contain a bath of cryogenic fluid, the enclosure housing a compression chamber communicating with the bath and a movable piston configured to compress the fluid in the compression chamber, the piston being mounted at a first end of a rod, the apparatus comprising a drive mechanism driving a second end of the rod in a back and forth movement in a longitudinal direction, the drive mechanism comprising a motor equipped with a rotary shaft and a mechanical conversion system converting the rotational movement of the rotary shaft into a translational movement, in the configuration of operation of the installation, the longitudinal direction of travel of the piston rod being vertical, the motor being fixed rigidly to an upper mounting structure, wherein the mechanical conversion system is located vertically above the enclosure and is rigidly connected to a motor via a tubular structure positioned around the rotary shaft, the tubular structure comprising a first end rigidly connected to the motor and/or to a casing surrounding same and a second end rigidly connected to the mechanical conversion system and/or to a casing surrounding same, said tubular structure being able and configured to absorb at least some of the torque and/or the forces generated in the transmission of movement between the motor and the enclosure.

12. The installation as claimed in claim 11, wherein the mechanical conversion system converting the rotational movement of the rotary shaft into a translational movement of the piston rod is of the connecting rod/crank type.

13. The installation as claimed in claim 11, wherein the tubular structure comprises an opening for access to the rotary shaft.

14. The installation as claimed in claim 11, wherein the tubular structure is made up of several assembled parts.

15. The installation as claimed in claim 11, wherein the rotary shaft is coupled to the mechanical conversion system via an axle comprising a connecting system selected from the group consisting of a rigid connection and a Cardan joint.

16. The installation as claimed in claim 11, wherein the motor is suspended from the upper mounting structure.

17. The installation as claimed in claim 11, wherein the mechanical conversion system is suspended from the motor via the tubular structure.

18. The installation as claimed in claim 11, wherein the fluidtight enclosure is suspended from the mechanical conversion system.

19. The installation as claimed in claim 11, further comprising a tank of liquefied gas, said tank being fluidically connected by a set of pipes to the enclosure, these pipes being configured to supply the compression chamber with fluid that is to be compressed and to recover the fluid that has vaporized in the enclosure.

20. A station for filling tanks or pipes with pressurized gas and comprising a source of liquefied gas, a withdrawal circuit having a first end connected to the source and at least one second end intended to be connected to a tank to be filled, the withdrawal circuit comprising an installation as claimed in claim 11.
